(19) United States
(12) Patent Application Publication
(10) Pub. No.: US 2023/0389611 A1
(43) Pub. Date: Dec. 7, 2023

(54) A Cartridge for an Aerosol Generating Device, an Aerosol Generating Device and an Aerosol Generating System

(71) Applicant: JT International SA, Geneva (CH)

(72) Inventors: Alec Wright, Guildford (GB); Andrew Robert John Rogan, Forres (GB); Kyle Adair, Lisburn (GB); Olayiwola Olamiposi Popoola, Walton-on-Thames (GB); Peter Loveday, Epsom (GB)

(73) Assignee: JT International SA, Geneva (CH)

(21) Appl. No.: 18/034,218

(22) PCT Filed: Oct. 27, 2021
(86) PCT No.: PCT/EP2021/079875

§ 371 Date: Apr. 27, 2023

(30) Foreign Application Priority Data
Oct. 29, 2020 (EP) 20204758.5

(51) Int. Cl. A24F 40/465; A24F 40/10; A24F 40/42; A24F 40/44; H05B 6/10

(52) U.S. Cl. CPC A24F 40/465; A24F 40/10; A24F 40/42; A24F 40/44; H05B 6/108

(57) ABSTRACT

A cartridge for an aerosol generating device includes a reservoir for containing an aerosol generating liquid, an inductively heatable susceptor for heating the aerosol generating liquid, and a liquid transfer element configured to convey aerosol generating liquid from the reservoir towards the inductively heatable susceptor. The inductively heatable susceptor includes a susceptor ring extending around the liquid transfer element. The cartridge includes a recess configured for receiving, in a releasable connection a coil support having an induction coil of an aerosol generating device. An aerosol generating device, and an aerosol generating system including the aerosol generating device and a cartridge releasably connected to the aerosol generating device, are also described.

### TECHNICAL FIELD

The present disclosure relates generally to a cartridge for an aerosol generating device configured to heat an aerosol generating liquid to generate a vapour which cools and condenses to form an aerosol for inhalation by a user of the device. Embodiments of the present disclosure also relate to an aerosol generating device and/or to an aerosol generating system comprising an aerosol generating device and a cartridge configured to be used with the aerosol generating device.

### TECHNICAL BACKGROUND

The term aerosol generating device or vapour generating device (or more commonly electronic cigarette or e-cigarette) refers to a handheld electronic device that is intended to simulate the feeling or experience of smoking tobacco in a traditional cigarette. Electronic cigarettes work by heating an aerosol generating liquid to generate a vapour that cools and condenses to form an aerosol which is then inhaled by the user. Accordingly, using e-cigarettes is also sometimes referred to as “vaping”. The aerosol generating liquid usually comprises nicotine, propylene glycol, glycerine and flavourings.

Typical e-cigarette vaporizing units, i.e. systems or sub-systems for vaporizing the vapour generating liquid, utilize a cotton wick and heating element to produce vapour from liquid stored in a capsule or tank. When a user operates the e-cigarette, liquid that has soaked into the wick is heated by the heating element, producing a vapour which cools and condenses to form an aerosol which may then be inhaled. To facilitate the ease of use of e-cigarettes, cartridges are often used. These cartridges are often configured as “cartomizers”, which means an integrated component formed from a liquid store, a liquid transfer element (e.g. a wick) and a heater. Electrical connectors may also be provided to establish an electrical connection between the heating element and a power source. However, the complexity and numerous components of such cartridges are associated with drawbacks, such as a complex and costly manufacturing and/or assembly processes.

In view of the above, it would be desirable to provide a cartridge with improved manufacturability and/or assembly and which efficiently heats the aerosol generating liquid.

### SUMMARY OF THE DISCLOSURE

According to a first aspect of the present disclosure, there is provided a cartridge for an aerosol generating device, the cartridge comprising a reservoir for containing an aerosol generating liquid, an inductively heatable susceptor for heating the aerosol generating liquid, and a liquid transfer element configured to convey aerosol generating liquid from the reservoir towards the inductively heatable susceptor, wherein the cartridge comprises a recess configured for receiving in a releasable connection a coil support comprising an induction coil of an aerosol generating device.

The cartridge is intended for use with an aerosol generating device configured to heat the aerosol generating liquid to volatise at least one component of the aerosol generating liquid and thereby generate a vapour which cools and condenses to form an aerosol for inhalation by a user of the aerosol generating device. The present disclosure is particularly applicable to a portable (hand-held) aerosol generating device.

According to a second aspect of the present disclosure, there is provided an aerosol generating device having a proximal end, a distal end, and a longitudinal axis extending between the proximal end and the distal end, the aerosol generating device comprising:
an induction coil; and
a coil support projecting from the proximal end which supports the induction coil and which is locatable, in use, in a recess formed in a cartridge configured for releasable connection to the aerosol generating device.

According to a third aspect of the present disclosure, there is provided an aerosol generating system comprising an aerosol generating device according to the second aspect and a cartridge releasably connected to the proximal end of the aerosol generating device, wherein the cartridge comprises an inductively heatable susceptor and a recess accommodating the coil support.

The cartridge may comprise a reservoir containing an aerosol generating liquid and a liquid transfer element configured to convey aerosol generating liquid from the reservoir towards the inductively heatable susceptor.

By providing a cartridge with a recess configured for receiving a coil support comprising an induction coil of an aerosol generating device, the induction coil can be positioned close to the inductively heatable susceptor and, hence, a good electromagnetic coupling can be achieved between the induction coil and the inductively heatable susceptor. Thus, the inductively heatable susceptor is heated efficiently by the electromagnetic field generated by the induction coil. Furthermore, by having the induction coil arranged in the aerosol generating device, the number of components within the cartridge is reduced and, thus, the structure of the cartridge can be simplified and the cost reduced.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

The recess may be positioned adjacent to the inductively heatable susceptor. Such an arrangement enables the induction coil to be positioned in close proximity to the inductively heatable susceptor and, hence, a good electromagnetic coupling to be achieved.

The liquid transfer element may extend in a transverse direction, substantially perpendicular to a longitudinal axis of the cartridge. This may enable aerosol generating liquid to be conveyed efficiently by the liquid transfer element from the reservoir to the inductively heatable susceptor. The recess may extend in a direction transverse to the direction of the liquid transfer element, substantially parallel to the longitudinal axis of the cartridge. The direction of extension of the recess corresponds to the direction of engagement of the induction coil and the coil support.

The liquid transfer element may comprise a first end which may be in fluid communication with aerosol generating liquid in the reservoir. The liquid transfer element may comprise a second end which may be in fluid communication with aerosol generating liquid in the reservoir. Thus, aerosol generating liquid can be conveyed efficiently from the reservoir to the inductively heatable susceptor, especially when the liquid transfer element comprises first and second ends in fluid communication with aerosol generating liquid in the reservoir.

The inductively heatable susceptor may contact the liquid transfer element. The inductively heatable susceptor may extend around the liquid transfer element. In some embodiments, the inductively heatable susceptor may form a ring around the liquid transfer element. Heat can be transferred efficiently from the inductively heatable susceptor to the liquid transfer element with these arrangements.

The liquid transfer element may be porous and may comprise a capillary material. The porous liquid transfer element contacts the aerosol generating liquid in the reservoir to enable absorption of the aerosol generating liquid by the capillary material, for example due to capillary action or wicking, and conveys the absorbed aerosol generating liquid towards the inductively heatable susceptor where it is heated to form a vapour. For example, the liquid transfer element may have an elongated rod shape with both ends extending into the reservoir.

The inductively heatable susceptor may be a susceptor ring that extends around (i.e., surrounds) the liquid transfer element, and more particularly the circular surface or the cylindrical surface of the liquid transfer element. The use of a susceptor ring may be advantageous as it provides continuous electrical circuit (i.e., a closed electrical path) in which eddy currents can readily flow. A better heating effect is thereby achieved, whilst at the same time allowing non-magnetic materials such as aluminium to be used in which magnetic hysteresis losses do not contribute to the heating effect.

Two separate susceptor rings (i.e., a pair of susceptor rings) may be provided, and the susceptor rings may be spaced axially relative to each other along the liquid transfer element. A first susceptor ring may be positioned proximate the first end of the liquid transfer element. A second susceptor ring may be positioned proximate the second end of the liquid transfer element. Such an arrangement helps to ensure that the liquid transfer element is heated uniformly along its length, thereby improving the efficiency of vapour generation.

The liquid transfer element may comprise a porous ceramic material or a fibrous material. The liquid transfer element has good structural rigidity, e.g., so that it is self-supporting, and at the same time has a sufficient level of porosity to convey aerosol generating liquid from the reservoir towards the inductively heatable susceptor.

The cartridge may comprise a pair of recesses which may be configured for receiving in a releasable connection a pair of supports comprising a pair of induction coils of an aerosol generating device. The recesses may be positioned proximate to the two ends of the liquid transfer element and at opposite sides. The cartridge may comprise an annular recess which may be configured for receiving in a releasable connection an annular support comprising a pair of induction coils of an aerosol generating device.

The pair of induction coils may be positioned proximate to the two ends of the liquid transfer element and at opposite sides. Such arrangements may permit a corresponding pair of inductively heatable susceptors to be used, thereby providing increased vapour generation.

The coil support may project from the proximal end in a direction substantially parallel to the longitudinal axis of the aerosol generating device. Such an arrangement facilitates releasable connection of a cartridge to the aerosol generating device, in particular because the coil support is easily locatable in the recess of the cartridge.

The induction coil may be a planar induction coil which may have a winding axis substantially perpendicular to the longitudinal axis of the aerosol generating device. The planar induction coil may be a flat spiral coil. Thus, the flat spiral coil may extend in a plane substantially parallel to the longitudinal axis of the aerosol generating device. A good electromagnetic coupling between the planar induction coil and the inductively heatable susceptor is obtained with this arrangement. The induction coil may comprise a Litz wire or a Litz cable. It will, however, be understood that other materials could be used.

The aerosol generating device may comprise a pair of said coil supports which may be transversely spaced and locatable, in use, in corresponding recesses formed in a cartridge configured for releasable connection to the aerosol generating device. Each coil support may support an induction coil. The aerosol generating device can be used with a cartridge having a corresponding pair of inductively heatable susceptors, thereby providing increased vapour generation.

The cartridge may further comprise a vaporization chamber and the liquid transfer element and the inductively heatable susceptor may be positioned in the vaporization chamber. The cartridge may further comprise an air inlet communicating with the vaporization chamber, for example with an inlet of the vaporization chamber, and a vapour outlet channel in communication with an outlet of the vaporization chamber. The vapour generated in the vaporization chamber may cool and condense to form an aerosol as it flows along the vapour outlet channel, from the vaporization chamber towards an end of the vapour outlet channel. The end of the vapour outlet channel may comprise a mouthpiece.

The aerosol generating liquid may comprise polyhydric alcohols and mixtures thereof such as glycerine and/or propylene glycol. The aerosol generating liquid may contain nicotine and may, therefore, be designated a nicotine-containing liquid. The aerosol generating liquid may contain one or more additives, such as a flavouring.

The inductively heatable susceptor may comprise one or more, but not limited, of aluminium, iron, nickel, stainless steel, copper, and alloys thereof, e.g. Nickel Chromium or Nickel Copper. With the application of an alternating electromagnetic field in its vicinity, for example generated by the induction coil, the susceptor may generate heat due to eddy currents and/or magnetic hysteresis losses resulting in a conversion of energy from electromagnetic to heat.

The induction coil may be arranged to operate in use with a fluctuating electromagnetic field having a magnetic flux density of between approximately 20 mT and approximately 2.0 T at the point of highest concentration.

The aerosol generating device may include a power source and may include circuitry. The power source and circuitry may be configured to operate at a high frequency. The power source and circuitry may be configured to operate at a frequency of between approximately 80 kHz and 500 kHz, possibly between approximately 150 kHz and 250 kHz, and possibly at approximately 200 kHz. The power source and circuitry could be configured to operate at a higher frequency, for example in the MHz range, depending on the type of inductively heatable susceptor that is used.

### BRIEF DESCRIPTION OF THE DRAWINGS

FIG. 1 is a diagrammatic view of an aerosol generating system comprising a first example of an aerosol generating device and a cartridge configured to be releasably connected to the aerosol generating device;

FIG. 2 is a diagrammatic view of the aerosol generating system shown in FIG. 1, with the cartridge releasably connected to the aerosol generating device;

FIG. 3 is a diagrammatic view from a proximal end of the first example of the aerosol generating device shown in FIGS. 1 and 2; and

FIG. 4 is a diagrammatic view from a proximal end of a second example of the aerosol generating device.

### DETAILED DESCRIPTION OF EMBODIMENTS

Embodiments of the present disclosure will now be described by way of example only and with reference to the accompanying drawings.

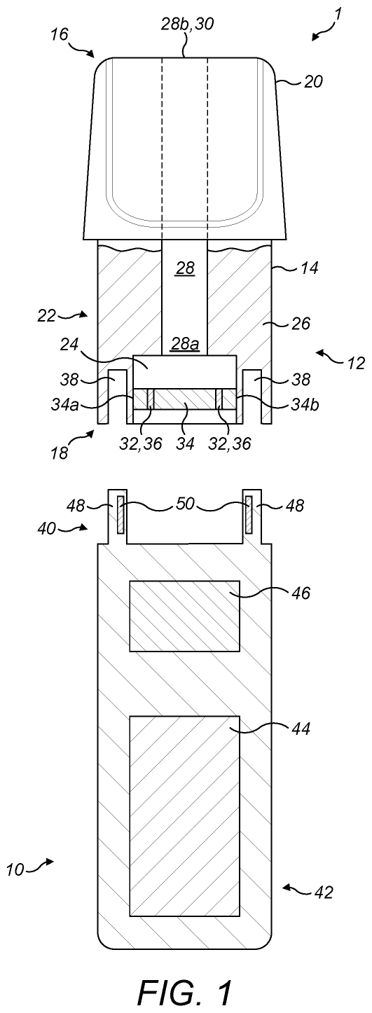

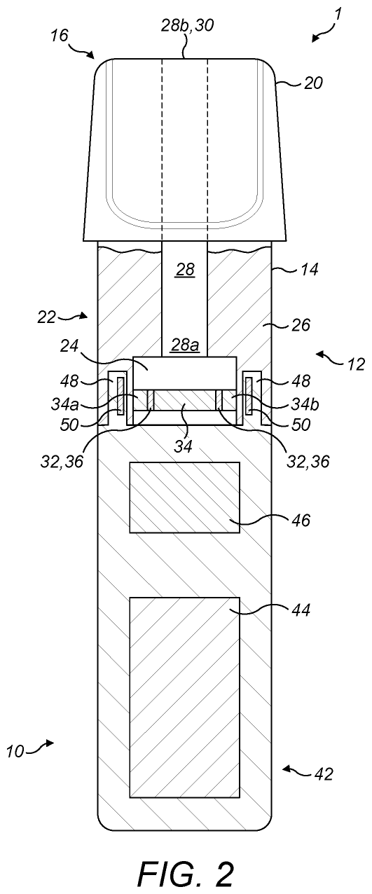

Referring initially to FIGS. 1 and 2, there is shown an aerosol generating device 10 and a cartridge 12 for use with the aerosol generating device 10 such that the aerosol generating device 10 and the cartridge 12 together form an aerosol generating system 1. The cartridge 12 is releasably connectable to the aerosol generating device 10 by a releasable connection. The releasable connection can, for example, be a snap-fit connection or alternatively a magnetic connection, a threaded connection, or a bayonet connection.

The cartridge 12 comprises a cartridge housing 14 having a proximal end 16 and a distal end 18. The proximal end 16 may constitute a mouthpiece end configured for being introduced directly into a user's mouth and may, therefore, also be designated as the mouth end 16. In the illustrated example, a mouthpiece cover 20 is fitted to the proximal (mouth) end 16 and may be secured in position on the cartridge housing 14 by a snap-fit connection or glue. The cartridge 12 comprises a liquid storage portion 22 and a vaporization chamber 24. The liquid storage portion 22 comprises a reservoir (i.e., liquid store) 26 configured for containing therein an aerosol generating liquid, and a vapour outlet channel 28 having an outlet 28b at the proximal (mouth) end 16. The outlet 28b may constitute a mouthpiece 30 of the cartridge 12.

The aerosol generating liquid stored in the reservoir 26 may comprise an aerosol-forming substance such as propylene glycol and/or glycerol and may contain other substances such as nicotine and acids. The aerosol generating liquid may also comprise flavourings such as e.g. tobacco, menthol or fruit flavour. The reservoir 26 may extend generally between the proximal (mouth) end 16 and the distal end 18 and may surround, and coextend with, the vapour outlet channel 28.

The cartridge 12 comprises an inductively heatable susceptor 32 positioned in the vaporization chamber 24 and a liquid transfer element 34 also positioned in the vaporization chamber 24. The liquid transfer element 34 is configured to convey aerosol generating liquid from the reservoir 26 towards the inductively heatable susceptor 32 so that the aerosol generating liquid can be heated and vaporized.

In more detail, the liquid transfer element 34 comprises a capillary material, such as a porous ceramic material, and extends in a transverse direction, i.e., a direction substantially perpendicular to a longitudinal axis of the cartridge 12. The use of a porous ceramic material may be advantageous so that the liquid transfer element 34 has sufficient structural rigidity so that it is self-supporting. However, other types of capillary material (such as a bundle of fibres) can be used to form the liquid transfer element 34. The liquid transfer element 34 includes first and second ends 34a, 34b which are in fluid communication with the aerosol generating liquid in the reservoir 26. Thus, aerosol generating liquid can be absorbed from the reservoir 26 via the first and second ends 34a, 34b and conveyed by the liquid transfer element 34 towards the inductively heatable susceptor 32.

In the illustrated example, the inductively heatable susceptor 32 comprises a pair of susceptor rings 36 which extend around the liquid transfer element 34 and which may contact the liquid transfer element 34 to facilitate heat transfer from the susceptor rings 36 to the liquid transfer element 34. The susceptor rings 32 are spaced apart axially along the liquid transfer element 34, with a first susceptor ring 32 being positioned close to the first end 34a and a second susceptor ring 32 being positioned close to the second end 34b. Other configurations for the inductively heatable susceptor 32 are, however, entirely within the scope of the present disclosure. For example, the inductively heatable susceptor 32 could be encapsulated by the liquid transfer element 34. Alternatively, the inductively heatable susceptor 32 could comprise a particulate susceptor material which is distributed throughout the liquid transfer element 34.

The cartridge 12 further comprises a recess 38, and in the illustrated example a pair of transversely spaced recesses 38, positioned adjacent to the first and second ends 34a, 34b of the liquid transfer element 34, and more particularly adjacent to the susceptor rings 36. The recesses 38 serve an important purpose as will be discussed in further detail below.

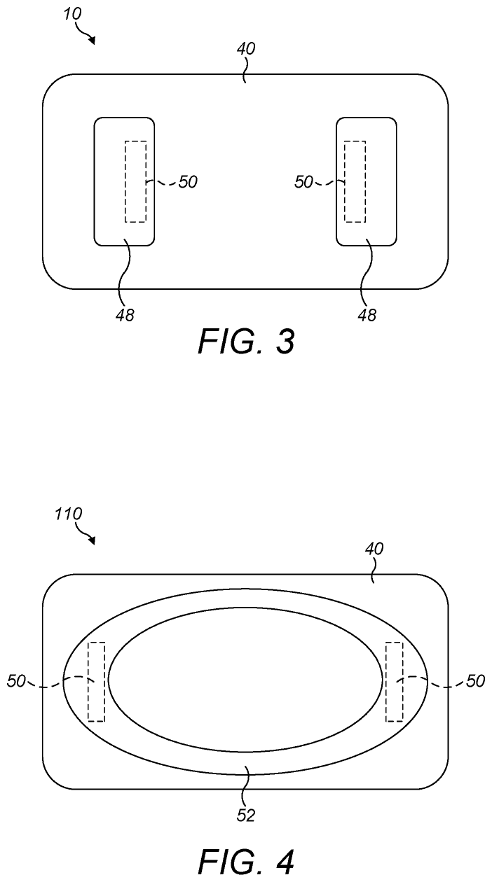

The aerosol generating device 10 has a proximal end 40 and a distal end 42, and comprises a power source 44 and control circuitry 46 which may be configured to operate at high frequency. The power source 44 typically comprises one or more batteries which could, for example, be inductively rechargeable. The aerosol generating device 10 further comprises a pair of transversely spaced coil supports 48 which project from the proximal end 40 in a direction substantially parallel to the longitudinal axis of the aerosol generating device 10 and a corresponding pair of induction coils 50 supported by the coil supports 48. The induction coils 50 are planar coils, for example flat spiral coils, which have a winding axis substantially perpendicular to the longitudinal direction of the aerosol generating device 10. Thus, as best seen in FIGS. 1 and 3, the induction coils 50 extend in a plane substantially parallel to the longitudinal axis of the aerosol generating device 10.

When the cartridge 12 is connected to the aerosol generating device 10 as shown in FIG. 2, the transversely spaced coil supports 48 are located in the corresponding transversely spaced recesses 38 formed in the cartridge 12. Thus, the induction coils 50 supported by the coil supports 48 are positioned adjacent to the susceptor rings 36.

In operation, and as will be understood by one of ordinary skill in the art, when the aerosol generating device 10 is activated, the susceptor rings 36 are inductively heated by the induction coils 50 positioned in the recesses 38, and more specifically by the alternating electromagnetic field generated by the induction coils 50. More particularly, eddy currents and/or magnetic hysteresis losses are generated in the susceptor rings 36 causing them to heat up. The heat is transferred from the susceptor rings 36 to the liquid transfer element 34, for example by conduction, radiation and convection, thereby heating the liquid transfer element 34. The aerosol generating liquid absorbed from the reservoir 26 by the liquid transfer element 34 is thereby heated, resulting in the generation of a vapour which escapes from the liquid transfer element 34 into the vaporization chamber 24. The vapour then flows from the vaporization chamber 24, and into the vapour outlet channel 28 via an inlet 28a. As the vapour flows along the vapour outlet channel 28, it cools and condenses to form an aerosol that is inhaled by a user through the mouthpiece 30 formed by the outlet 28b. The vaporization of the aerosol generating liquid is facilitated by the addition of air from the surrounding environment through one or more air inlets (not shown) at the distal end 18 of the cartridge 12. The flow of air and/or vapour through the cartridge 12, i.e. from the one or more air inlets, through the vaporization chamber 24, along the vapour outlet channel 28, and out of the mouthpiece 30, is aided by negative pressure created by a user drawing air from the proximal (mouth) end 16 using the mouthpiece 30.

After the aerosol generating liquid in the cartridge 12 has been depleted, the cartridge 12 can be disconnected from the aerosol generating device 10 and a replacement cartridge 12 can then be connected in its place, to allow further use of the aerosol generating system 1 in the manner described above.

Referring to FIG. 4, there is shown a second example of an aerosol generating device 110 which is similar to the aerosol generating device 10 described above with reference to FIGS. 1 to 3 and in which corresponding components are identified using the same reference numerals.

The aerosol generating device 110 comprises an annular coil support 52 which supports the transversely spaced induction coils 50. The aerosol generating device 110 is configured for use with a cartridge 12 having an annular recess 38 instead of a pair of transversely spaced recesses 38 as described above with reference to FIGS. 1 and 2. When the cartridge 12 is connected to the aerosol generating device 110, the annular coil support 52 is located in the corresponding annular recess 38 in the cartridge 12 and the transversely spaced induction coils 50 are thereby located adjacent to the first and second ends 34a, 34b of the liquid transfer element 34 and, hence, adjacent to the susceptor rings 36. The aerosol generating device 110 operates in the same way as the aerosol generating device 10 described above to inductively heat the susceptor rings 36.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. A cartridge for an aerosol generating device, the cartridge comprising:
a reservoir for containing an aerosol generating liquid,
an inductively heatable susceptor for heating the aerosol generating liquid, and
a liquid transfer element configured to convey aerosol generating liquid from the reservoir towards the inductively heatable susceptor,
wherein the inductively heatable susceptor comprises a susceptor ring extending around the liquid transfer element and the cartridge comprises a recess configured for receiving in a releasable connection, a coil support comprising an induction coil of an aerosol generating device.

2. The A cartridge according to claim 1, wherein the recess is positioned adjacent to the inductively heatable susceptor.

3. The cartridge according to claim 1, wherein the inductively heatable susceptor contacts the liquid transfer element.

4. The cartridge according to claim 1, wherein the liquid transfer element extends in a transverse direction, perpendicular to a longitudinal axis of the cartridge.

5. The cartridge according to claim 4, wherein the liquid transfer element comprises a first end and a second end both in fluid communication with aerosol generating liquid in the reservoir.

6. The cartridge according to claim 1, wherein the inductively heatable susceptor ring comprises a pair of susceptor rings extending around the liquid transfer element.

7. The cartridge according to claim 6, wherein the pair of susceptor rings are spaced axially relative to each other along the liquid transfer element.

8. The cartridge according to claim 1, wherein the liquid transfer element comprises a porous ceramic material or a fibrous material.

9. The cartridge according to claim 1, wherein the recess comprises a pair of recesses configured for receiving, in a releasable connection, a pair of coil supports comprising a pair of induction coils of an aerosol generating device.

10. The cartridge according to claim 1, wherein the recess comprises an annular recess configured for receiving, in a releasable connection, an annular support comprising a pair of induction coils of an aerosol generating device.

11. An aerosol generating device having a proximal end, a distal end, and a longitudinal axis extending between the proximal end and the distal end, the aerosol generating device comprising:
an induction coil; and
a coil support projecting from the proximal end, supporting the induction coil and locatable, in use, in a recess formed in a cartridge configured for releasable connection to the aerosol generating device;
wherein the induction coil is a planar induction coil having a winding axis substantially perpendicular to the longitudinal axis of the aerosol generating device.

12. The aerosol generating device according to claim 11, wherein the coil support projects from the proximal end in a direction substantially parallel to the longitudinal axis of the aerosol generating device.

13. The aerosol generating device according to claim 11, wherein the planar induction coil is a flat spiral coil.

14. The aerosol generating device according to claim 11, wherein the coil support comprises a pair of coil supports transversely spaced and locatable, in use, in corresponding recesses formed in the cartridge configured for releasable connection to the aerosol generating device, and
wherein the induction coil comprises a pair of induction coils, each coil support supporting one of the pair of planar induction coils.

15. The cartridge according to claim 7, wherein a first of the pair of susceptor rings is positioned proximate the first end of the liquid transfer element and a second of the pair of susceptor rings is positioned proximate the second end of the liquid transfer element.
